(19) United States
(12) Patent Application Publication
(10) Pub. No.: US 2006/0114327 A1
(43) Pub. Date: Jun. 1, 2006

(54) Photo movie creating apparatus and program

(75) Inventors: Hajime Araya, Kanagawa (JP); Kei Yamaji, Kanagawa (JP); Takayuki Iida, Kanagawa (JP); Fumihiro Sonoda, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM, CO., LTD.

(21) Appl. No.: 11/287,283

(22) Filed: Nov. 28, 2005

(30) Foreign Application Priority Data
Nov. 26, 2004 (JP) 2004-341533
Feb. 28, 2005 (JP) 2005-054368

(51) Int. Cl. H04N 5/225; H04N 9/04

(52) U.S. Cl. 348/207.99

(57) ABSTRACT

A photo movie is created based on scene configuration information, which includes scene definition information to determine a type of special effects, the number of still images, and playback time for each scene. The playback time is summed up to figure total playback time of the photo movie. If an intended total playback time is specified by a user, the playback time and scene configuration are changed in each scene so that the total playback time of the photo movie corresponds with the intended total playback time. In another embodiment, a moving speed of a cropping frame for cutting out a portion of a still image is derived from a moving path of the cropping frame and a total playback time of a photo movie. The size of the cropping frame is changed if the calculated moving speed is out of an allowable speed range.

### BACKGROUND OF THE INVENTION

1. Field of the Invention

The present invention relates to a photo movie creating apparatus and program for creating a photo movie from still images.

2. Background Arts

There are known apparatuses and software for creating a photo movie from still images captured with digital cameras or the like (see, for example, the Japanese patent laid-open publications No. 10-200843 and No. 2002-24846, “LiFE* with PhotoCinema” from Digitalstage inc., searched on Nov. 1, 2004, via the Internet,<URL:http://www.digitalstage.net/jp/product/life/i ndex.html>, “Digicam de!! movie theater” from A.I.Soft inc., searched on Nov. 1, 2004, via the Internet, <URL: http://ai2you.com/imaging/products/dcmtheater/dcmt.asp>, “Imaginate 2.0” from Canopus Co., Ltd, searched on Nov. 1, 2004, via the Internet, <URL: http://www.canopus.co.jp/catalog/imaginate/imagenate20_inde x.htm>). The photo movie is made up of the still images with dynamic visual effects added thereto. The photo movie will effectively spotlights a certain person and gives a story to the images, offering better presentation of images than a slide show, which merely displays a set of images one after another. The photo movies is typically played back with dedicated reproducing devices or computers installed with one of the above software. In addition, when the image data of the photo movie is transformed into a common digital video format and recorded to an optical disc, such as DVD, the photo movie can be played back with home DVD players.

The special effects that add movement to the still images will include an electronic zooming effect for zooming in and out on a portion of an image, an electronic panning effect for scrolling a close-up image, a frame move effect for moving the reduced still image linearly or curvedly on the screen, a rotation effect for turning an image around a certain point, a skew effect for skewing (or twisting) an image, and a combination of these effects. Furthermore, the photo movie accepts a wide variety of display methods and it is possible to display plural reduced still images together (multiple screen display), synthesize animated and decorative images with captions, or insert a slide show.

The photo movie is composed of plural scenes with different content. To determine the content, each of these scenes is given scene definition information, which includes parameters for the type of special effects, the number of still images to be used, and playback time. A scene configuration of the entire photo movie is determined by scene configuration information which describes a sequence of the scenes. For example, the Japanese patent laid-open publications No. 10-200843 discloses the photo movie creating device which stores scene configuration information to specify a special effect and still image for each scene and creates a photo movie based on this scene configuration information.

The photo movie may however become too long when a lot of still images are used, hence the “Digicam de!! movie theater” allows a user to specify an total playback time of the photo movie.

However, the “Digicam de!! movie theater” removes some of the still images from the photo movie to reduce the total playback time, and the created photo movie would be unsatisfactory when an important image to the user is removed. Additionally, the playback time of each scene is difficult to change because it is only achieved through manual operation.

By the way, in order to create high quality photo movies, the special effects must be set up properly based on the resolution and composition of the still images. The photo movie creating software of the “Imaginate 2.0” therefore allows a user to determine the setup of the special effects.

For the zooming and panning effects, for example, a cropping frame which defines a cut off region of a still image is provided. The size of the cropping frame and start/end and intermediate points of the effect can be specified by the user, and thereby a moving path of the cropping frame is fixed to pass the specified points. The moving speed of the cropping frame depends on the playback time of the scene, and if the playback time of the scene is set at, for example, 5 seconds, the cropping frame will cuts off 150 frames (30 frames/sec×5 seconds) from the still image.

However, if the moving path of the cropping frame is too long, the cropping frame will move so fast that the image scrolls on the screen unduly busy. If the moving path of the cropping frame is too short, on the other hand, the cropping frame will move so slow that the photo movie becomes repetitive and boring.

### SUMMARY OF THE INVENTION

In view of the foregoing, an object of the present invention is to provide a photo movie creating apparatus and program capable of changing the total playback time of the photo movie without changing the number of still images to be used in the photo movie.

Another object of the present invention is to provide a photo movie creating apparatus and program capable of adjusting the size and a moving path of a cropping frame which has been set up inappropriately with regard to playback time of a scene, while maintaining a creator's intention.

To achieve the above and other objects, the photo movie creating apparatus of the present invention includes a memory, a total playback time calculator, and a total playback time adjuster. The memory previously stores scene definition information which is given to each scene and includes at least one of parameters of the type of the special effects, the number of the still images to be used, and playback time of each of the scenes. The total playback time calculator calculates total playback time of the photo movie based on scene configuration information which is composed of a plurality of the scene definition information. The total playback time adjuster changes the scene definition information without changing the total number of still images to be used in the photo movie when an intended total playback time is provided by a user, as a condition for creating the photo movie, so that the total playback time corresponds with the intended total playback time.

The photo movie creating apparatus may also include a scene configuration information creator for creating the scene configuration information according to either a first step that enables a user to select a template of the scene definition information for each scene or a second step that enables the user to select a template of the scene configuration information.

A photo movie creating program of the present invention operates a computer to execute a process of creating a photo movie. The process includes the step of calculating total playback time of the photo movie based on scene configuration information, and the step of changing the scene definition information without changing the total number of still images to be used in the photo movie when an intended total playback time is provided by a user, so that the total playback time corresponds with the intended total playback time.

A photo movie creating apparatus of another embodiment includes a moving speed calculator and a frame size adjuster. The moving speed calculator calculates a moving speed of a cropping frame which cuts off a portion of the still image while moving on a moving path connecting at least two points on the still image. The frame size adjuster compares the calculated moving speed with a predetermined allowable speed range and changes the size of the cropping frame when the moving speed is out of the allowable speed range.

The photo movie creating apparatus of another embodiment may also include a moving distance adjuster for changing a length of the moving path of the cropping frame while maintaining the connection of the points when the moving speed is out of the allowable speed range.

A photo movie creating program of another embodiment operates a computer to execute a process of creating a photo movie. The process includes the step of calculating a moving speed of the cropping frame, and the step of comparing the moving speed with a predetermined allowable speed range and changing the size of the cropping frame when the calculated moving speed is out of the allowable speed range.

According to the photo movie creating apparatus and program of the present invention, the total playback time of a photo movie is adjusted by changing the type and the number of the scene definition information in the scene configuration information. Since no still image is added or removed in the adjustment, the created photo movie will be highly satisfactory. Moreover, since the playback time is adjusted on a scene basis, the total playback time of the photo movie can be finely adjusted by one second, and there is no need to adjust the total playback time with an unreasonable method such as the fast or slow speed playback.

Additionally, the magnification of a still image will be changed when the moving distance of the still image is going to change in a scene whose playback time is adjusted. The photo movie therefore looks natural even after the adjustment. Furthermore, since the type of special effects is unchanged for each scene in the adjustment, the created photo movie is going to have an appropriate total playback time while maintaining the impression intended initially. Also, if the photo movie contains the scenes with the special effect that uses plural still images, these scenes may either incorporate the still images of other scenes or release certain images into newly created scenes so that several scenes can be removed from or added to the photo movie. The total playback time of the photo movie can thereby be adjusted substantially.

Since the scene configuration information is generated either by a step of determining the parameters in each scene or another step of using templates of scene configuration, a user can select to create an elaborate photo movie or an easy-to-create photo movie.

In accordance with another embodiment of the present invention, the size of the cropping frame is changed depending on the moving speed of the cropping frame. When the moving speed is excessively fast, the frame size is enlarged so that the cropped images will scroll slowly on the screen. When the moving speed is excessively slow, on the other hand, the frame size is reduced so that the cropped images will scroll quickly on the screen. Created in this way, the photo movie proceeds at a proper pace, i.e. not too quick nor too slow, and it becomes more satisfactory to convey the creator's intention than those created with the cropping frame that is only adjusted of the moving path and the moving speed. Also, the quality of the photo movies is never lowered because there is no need to change the moving speed of the cropping frame even if the playback time is necessarily adjusted, for any reason, after the proper setup of the moving speed and the playback time.

Additionally, since the moving distance of the cropping frame is adjusted in accordance with the change in size of the cropping frame in the frame size adjustment, a variable range of the playback time can be broadened.

Also, the moving distance is shortened if the cropping frame goes out of the still image. Therefore, any other portion than the still image will never show up, for example, in the form of a blacked out image in the photo movies.

### BRIEF DESCRIPTION OF THE DRAWINGS

For more complete understanding of the present invention, and the advantage thereof, reference is now made to the following descriptions taken in conjunction with the accompanying drawings, in which:

FIG. 1 is a block diagram of a photo movie creating apparatus in accordance with the present invention;

FIG. 2 is an explanatory view illustrating scene configuration information;

FIGS. 3A and 3B are explanatory views of a zooming effect, in which FIG. 3A shows an original image and a cropping frame, and FIG. 3B shows a created scene;

FIGS. 4A and 4B are explanatory views of a panning effect, in which FIG. 4A shows an original image and a cropping frame, and FIG. 4B shows a created scene;

FIGS. 5A to 5C are explanatory views illustrating a total playback time adjustment of a photo movie by changing playback time of each scene, in which FIG. 5A shows each scene of the photo movie before adjustment, FIG. 5B shows each scene of the photo movie whose total playback time is extended, and FIG. 5C shows each scene of the photo movie whose total playback time is reduced;

FIGS. 6A to 6C are explanatory views illustrating a total playback time adjustment of a photo movie by changing scene configuration, in which FIG. 6A shows each scene of the photo movie before adjustment, FIG. 6B shows each scene of the photo movie whose total playback time is extended, and FIG. 6C shows each scene of the photo movie whose total playback time is reduced;

FIG. 7 is a flow chart of photo movie creating procedure;

FIG. 8 is a block diagram of a photo movie creating apparatus in accordance with another embodiment of the present invention;

FIGS. 9A and 9B are explanatory views of a cropping frame, in which FIG. 9A shows a still image and the cropping frame, and FIG. 9B shows components of the cropping frame;

FIG. 10 is an explanatory view illustrating a photo movie with the panning effect;

FIGS. 11A to 11C are explanatory views of adjusting size of the cropping frame, in which FIG. 11A shows the cropping frame before adjustment, FIG. 11B shows the enlarged cropping frame, and FIG. 11C shows the reduced cropping frame;

FIGS. 12A to 12C are explanatory views of adjusting a moving distance of the cropping frame, in which FIG. 12A shows the cropping frame before adjustment, FIG. 12B shows the decreased moving distance of the cropping frame, and FIG. 12C shows the increased moving distance of the cropping frame;

FIGS. 13A to 13C are explanatory views of adjusting the cropping frame that goes out of the still image, in which FIG. 13A shows the cropping frame before adjustment, FIG. 13B shows a size adjustment to the cropping frame, and FIG. 13C shows a moving distance adjustment to the cropping frame; and

FIGS. 14 and 15 are flow charts of photo movie creating procedure in accordance with another embodiment of the present invention.

### DESCRIPTION OF THE PREFFERED EMBODIMENTS

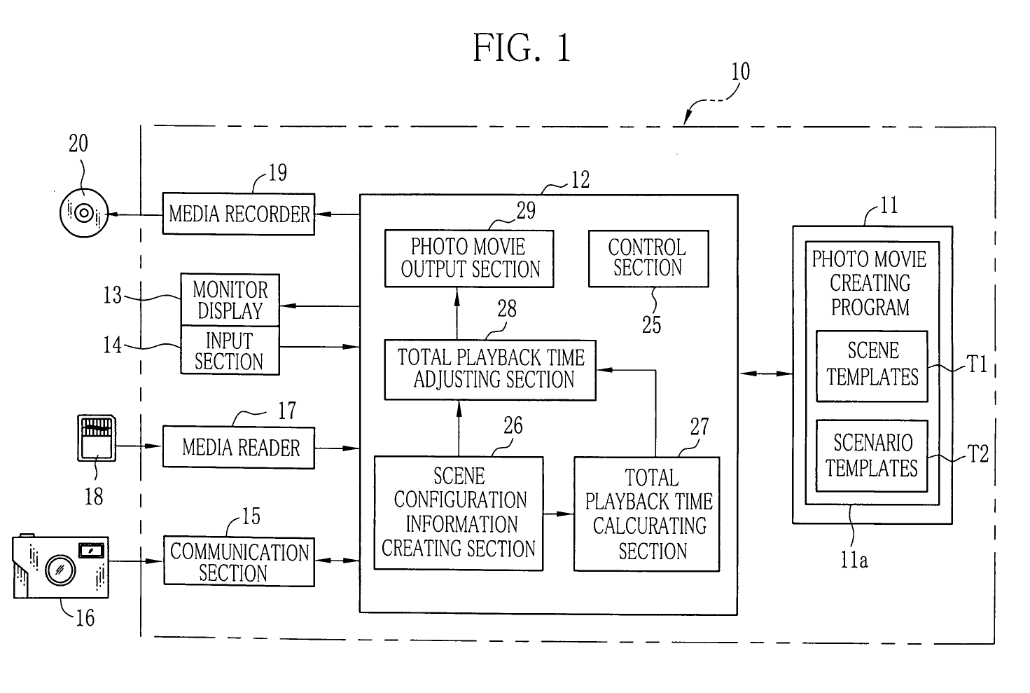

Referring to FIG. 1, a photo movie creating apparatus 10 is installed at DPE shops which offer a photo printing service, and operated by a customer. The photo movie creating apparatus 10 includes a memory 11, a CPU 12, a monitor display 13, an input operation section 14, a communication section 15, a media reader 17, and a media recorder 19. The memory 11, such as a hard disk type magnetic storage device, stores still image data for a photo movie and intermediate data produced in the arithmetic processing of the CPU 12, as well as a photo movie creating program 11a and other control programs. The CPU 12 runs each program stored in the memory 11.

The monitor display 13 displays an edit menu as well as the created photo movies. The input operation section 14 will be, for example, a touch panel that constitutes a screen of the monitor display 13. By touching keys on the screen, parameters for photo movie creation are entered. The communication section 15 sends and receives image data to an external device such as the digital camera 16. The media reader 17 reads out the image data from the memory card 18 brought in by a customer. The media recorder 19 records the created photo movies to optical disc 20 such as CD or DVD.

When the photo movie creating program 11a in the memory 11 is started, the CPU 12 functions as several different sections, such as a control section 25 to control every section in response to the operations on the input operation section 14, a scene configuration information creating section 26, a total playback time calculating section 27, a total playback time adjusting section 28, and a photo movie output section 29.

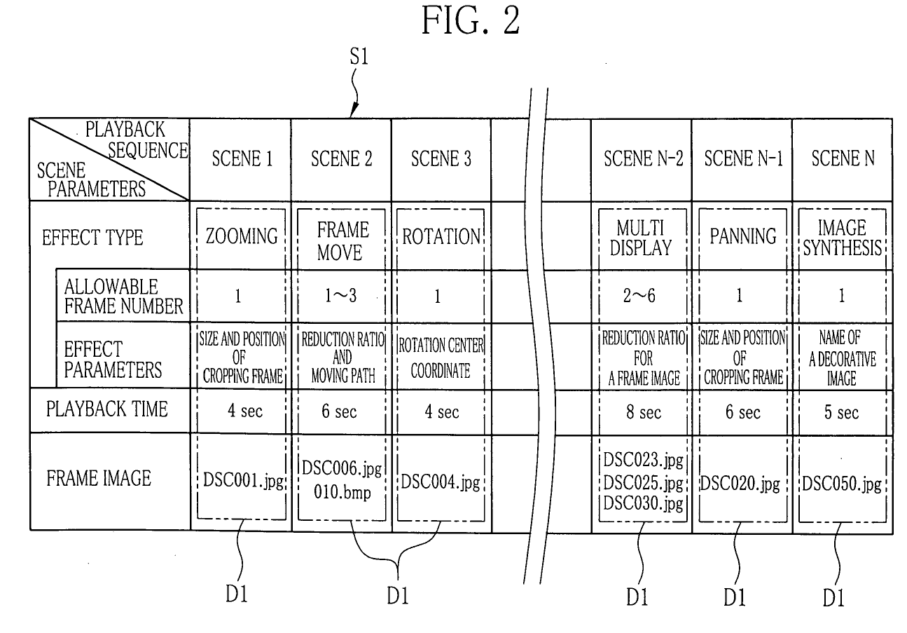

Based on the instruction from the customer, the scene configuration information creating section 26 creates scene configuration information S1 by associating the read data of still images (or frame images) to either a scene template T1 or a scenario template T2 stored in the photo movie creating program 11a. The scene configuration information S1, as shown in FIG. 2, is made up of plural scenes of a photo movie and scene definition information D1 for each scene which are arranged in a playback order. The scene definition information D1 specifies parameters of a scene (scene parameters) such as an effect type, a file name of a frame image to be used, and playback time.

The scene template T1 is the scene definition information that previously specifies the effect type and playback time, and there are a zooming template, a frame move template, and a panning template or the like. With using the scene template T1, each scene of a photo movie can be created only by specifying a still image to be used. The plural scenes created in this way are combined to produce a unique scene configuration in the photo movie.

The scenario template T2 is the scene configuration information that previously specifies all the parameters but still images. The scenario template T2 comes in many types to meet various themes such as the personal events like a wedding ceremony and a graduation ceremony and the public events like New Year's day and Christmas day. With using the scenario template T2, a photo movie can be easily created only by specifying still images to be used. The user can use either the scene template T1 or the scenario template T2.

In the effect type parameter, a limiting number of the images and effect parameters should be also specified. Every effect has its own limit on the number of usable images, which is set at, for example, 1 frame for the zooming and the panning effects while at 1-3 frames for the frame move effect and at 2-6 frames for the multiple display effect. When the number of images is specified within the limit, playback time of the scenes are set at initial values based on the effect type and the number of images. For example, the initial value of a scene with the zooming effect will be 5 seconds, while that of a scene with the frame move effect will be 4 seconds when a single frame image is used, or 6 seconds when 2 frame images are used, or 8 seconds when 3 frame images are used. It is sure that these playback times can be changed later.

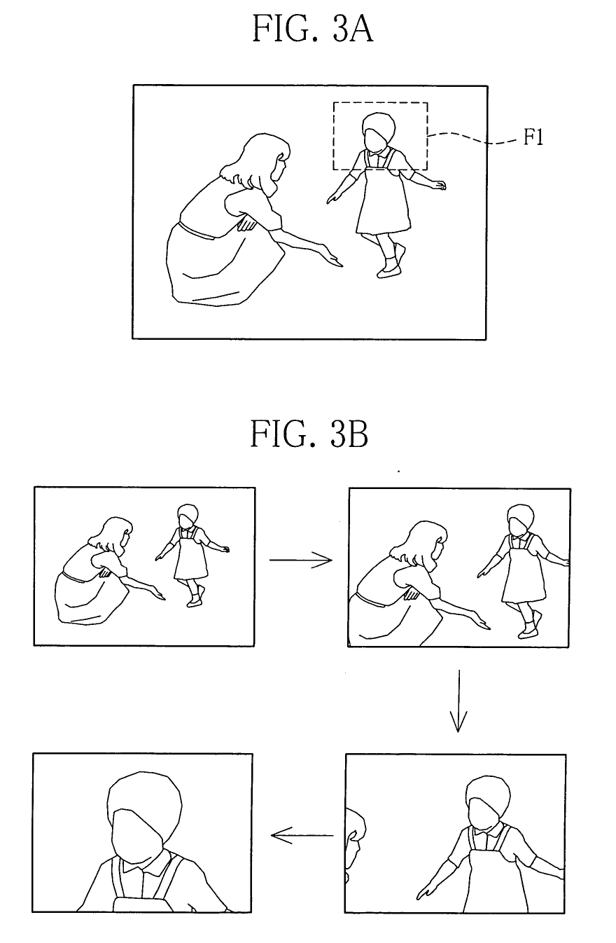

The effect parameters determine details of the effect. In the zooming effect, for example, a cropping frame F1 shown in FIG. 3A can be set up which determines the display range and the magnification of a still image at the end of the zooming. As shown in FIG. 3B, the photo movie from a mother and child frame image will begin with the image of these two people, proceeds to the gradual zooming up images to the child's face, and ends with the close-up image of the child's face. In this case, the position of the cropping frame F1 determines the main subject placed in the center of the screen at the end of the zooming. Further, the size of the cropping frame F1 determines the magnification of the main subject.

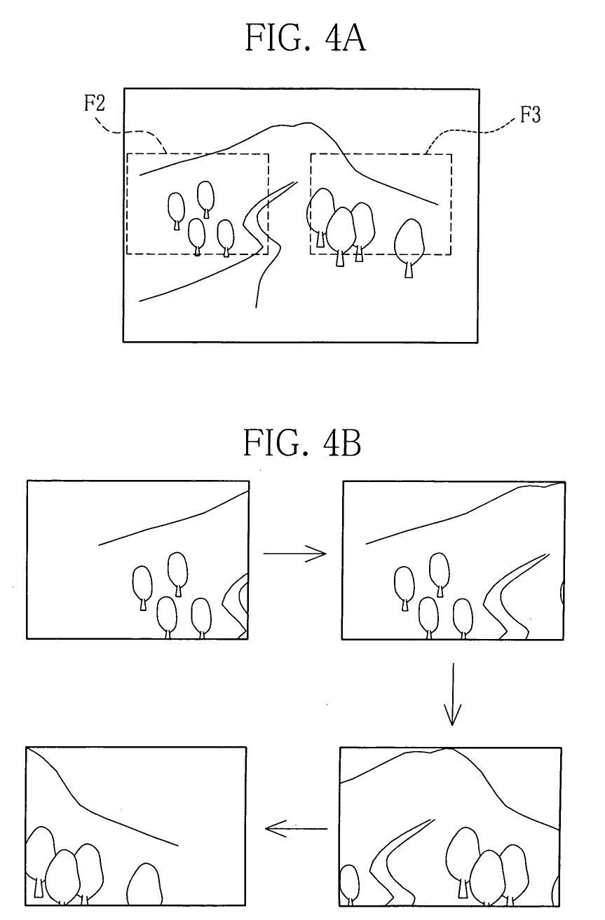

In the panning effect, as shown in FIG. 4A, what is arranged is cropping frames F2 and F3 which respectively decide a start point and an end point of panning. The photo movie from a distant image of a mountain as shown in FIG. 4B begins with the image of the left mountain foot defined with the cropping frame F2, proceeds to the images of the mountainside and the mountaintop viewed as if a camera is panning from left to right, and ends with the image of the right mountain foot defined with the cropping frame F3.

In the frame move effect, the number of frame images, a moving path and magnification of each frame image can be set up. One of such shapes as circle, triangle, and square can be selected as the moving path, on which the reduced frame image moves in the screen. In the rotation effect, coordinates of the rotation center can be set up. In the multiple display effect, the number of frame images and the magnification of each frame image can be set up.

The total playback time calculating section 27 calculates total playback time of a photo movie by summing up the playback time of all scenes, which are specified in the scene configuration information S1 generated by the scene configuration information creating section 26. In case that an intended total playback time is specified by the user, the total playback time adjusting section 28 firstly compares the intended total playback time with the calculated total playback time and makes some changes both to the scene definition information and the scene configuration information so that the total playback time of the photo movie will correspond with the intended total playback time. Alternatively, in case that background music is specified instead of the intended total playback time, the total playback time adjusting section 28 adjusts the total playback time of the photo movie to correspond with the playback time of the specified background music.

Here, assuming that the total playback time is calculated to 12 minutes and if the intended total play back time of 10 minutes is specified, the scene configuration information S1 is changed to reduce the current total playback time for 2 minutes. If the intended total play back time of 15 minutes is specified, the scene configuration information is changed to extend the current total playback time for 3 minutes.

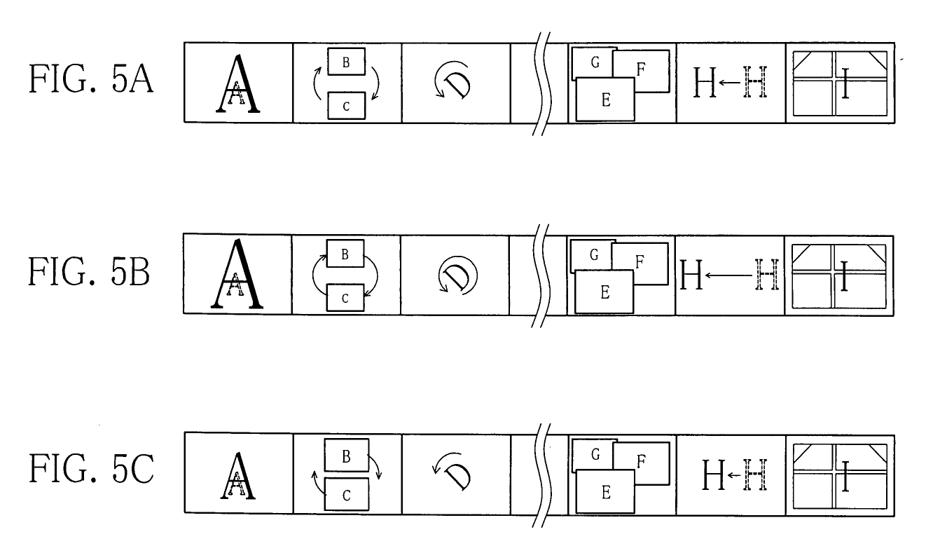

In changing the scene configuration information, considered are the total number of frame images used in the photo movie, the number of scenes, the content of the frame definition information D1, and the length of time to reduce or extend the photo movie. When the amount of change to the total playback time is relatively small with respect to the total numbers of the frame images and the scenes, the playback time of each scene is reduced or extended, as shown in FIG. 5. Consequently, the amount of move of the frame image is also changed in each scene.

In the zooming effect, for example, the size of the cropping frame F1 is changed and the magnification of the frame image is, therefore, changed at the end of the zooming. In the frame move effect, the moving distance and the magnification of each frame image are changed. In particular, the magnification becomes larger as the moving distance becomes smaller. In the panning effect, the cropping frames F2 and F3 are changed either in position or size and, therefore, at least the range or time of the panning is changed. By changing the playback time of each scene in this manner, the total playback time of the photo movie is finely adjusted by one second. Note that the playback time of each scene must be longer than its lower limit, which is determined according to the effect type and the number of images.

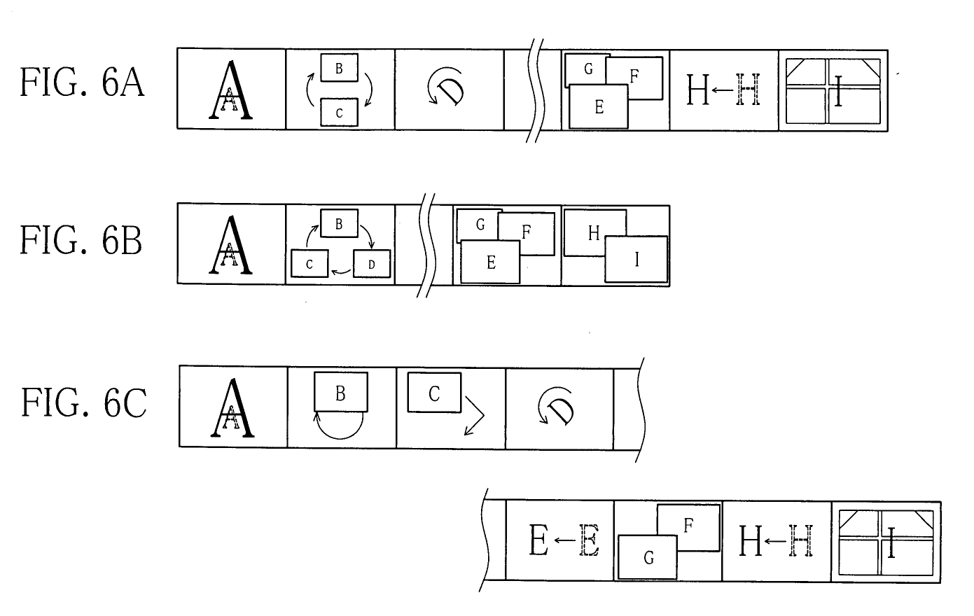

When the amount of change to the total playback time is relatively large with respect to the total numbers of the frame images and the scenes, the number of scenes and the number of scene definition information are changed as well as the playback time of each scene. To reduce the total playback time of the photo movie shown in FIG. 6A, for example, a frame image of a scene that contains only one frame image is released to an adjacent scene that contains plural frame images, as shown in FIG. 6B. Alternatively, one of the two adjacent scenes both of which contain only one frame image is changed to contain plural frame images so as to incorporate the frame image of the other scene. To extend the total playback time, in contrast, a scene with plural frame images is changed into plural scene each of which contains only one frame image, as shown in FIG. 6C. By adding or removing scenes in this manner, the total playback time of the photo movie is adjusted by several tens of second.

After the total playback time adjustment, the photo movie is output from the photo movie output section 29 in FIG. 1 in the form of moving image data such as the MPEG2-DVD-Video format. The moving image data is stored in the memory 11 and recorded to the optical disc 20 through the media recorder 19.

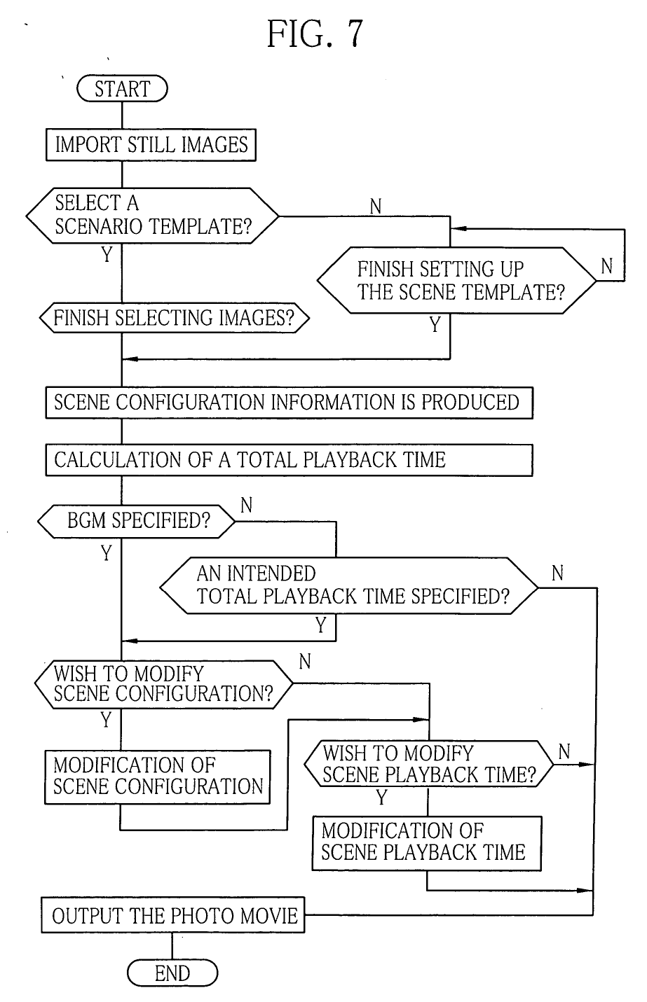

The operation of the photo movie creating apparatus 10 is now described with reference to the flowchart of FIG. 7. Firstly, the digital camera 16 or the memory card 18 storing the frame images for a photo movie is brought into a DPE shop. The digital camera 16 is connected to the communication section 15, while the memory card 18 is set in the media reader 17. The control section 25 reads out the data of the frame images from the digital camera 16 or the memory card 18 and stores the data in the memory 11. The scene configuration information creating section 26 executes either a manual step to use the scene templates Ti or an automatic step to use the scenario templates T2, which is selected by the user.

In, the automatic step, the scene configuration information S1 is created by associating the frame images in the memory 11 with one of the scenario templates selected by the user. For the scenes that use plural images, the number of the frame is automatically decided according to the total number of the read frame images. In the manual step, on the contrary, the scene configuration information S1 is created by specifying the type of effects and the images to be used in each scene.

Then the scene configuration information creating section 26 sends the scene configuration information Si to the total playback time calculating section 27. The total playback time calculating section 27 sums up the playback time of all the scenes which are specified in the scene configuration information S1. The sum is displayed as the total playback time of the photo movie on the monitor display 13. The monitor display 13 also displays the message of whether to use BGM in the photo movie. When using BGM, the user must specify one of the audio data stored in the digital camera 16 or the memory card 18.

The total playback time adjusting section 28 compares the total playback time of the photo movie with the playback time of the audio data and changes the scene configuration information S1 so that the photo movie will have the same playback time as the audio data. In case that it is more than twice as long as the audio playback time, the total playback is adjusted based on the multiple of the audio playback time.

When the BGM is not specified but an intended total playback time of the photo movie, the total playback time adjusting section 28 also changes the scene configuration information S1 so that the total playback time of the photo movie will correspond with the intended total playback time. Then, the scene configuration information S1 is sent to the photo movie output section 29, and the image data of the photo movie is stored in the memory 11. If neither of the BGM nor the intended total playback time is specified, the scene configuration information S1 is sent without change to the photo movie output section 29. And the image data of the photo movie is stored in the memory 11.

The image data of the photo movie in the memory 11 is written by the media recorder 19 to the optical disc 20, which is delivered to the customer with payment.

Although the photo movie creating apparatus 10 of the above embodiment is installed at DPE shops, it may be made up of an order accepting unit for creating the scene configuration information S1 and a photo movie output unit that receives the scene configuration information S1 from the order accepting unit to create the photo movie. In this case, the photo movie creating program 11a may be installed in a personal computer to enable a customer to make an order from home through a communicating means such as the Internet. The photo movie creating program 11a may also be installed in digital still cameras so that the photo movies can be played back or output immediately after image capturing.

Although, in the above embodiment, the playback time of each scene is adjusted by changing the amount of move of the frame image, it may also be adjusted by altering the amount of change in display form of the frame image. If a scene, for example, has an effect that changes the brightness of the frame image, its playback time can be adjusted by altering the range of brightness. Instead, if a scene has an effect that changes the tone of the frame image from monochrome to sepia to colors, its playback time can be adjusted by omitting the transition to sepia.

Although the scene definition information D1 of the above embodiment provides three parameters, i.e. the type of special effects, the number of images, and the playback time, the parameter of the playback time can be omitted for a scene that uses an effect with a fixed playback time. In the same manner, the parameter for the number of images can be omitted for a scene that uses an effect with a fixed number of images.

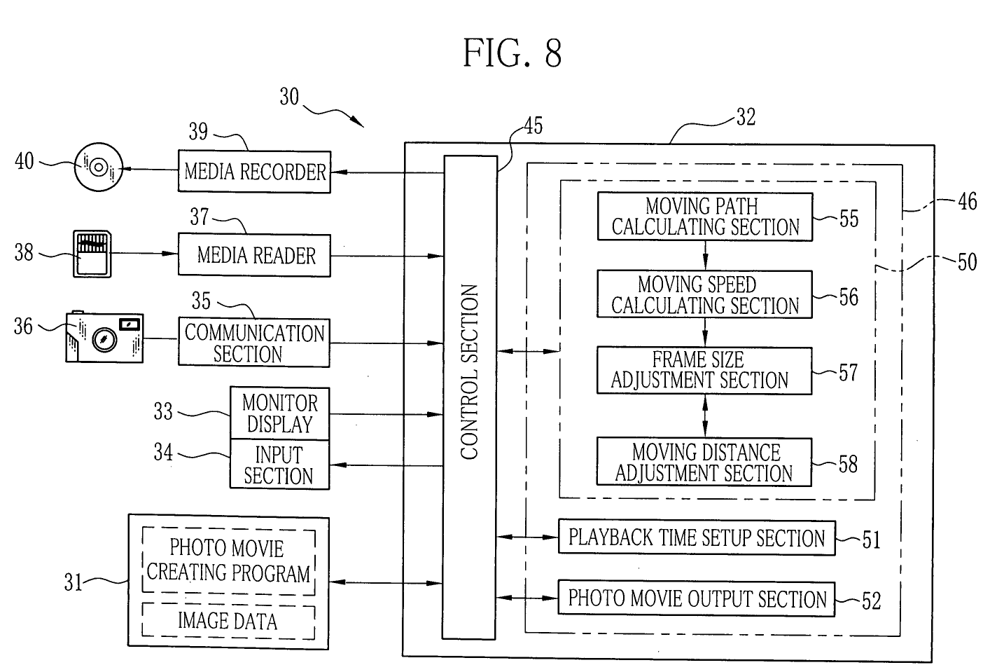

FIGS. 8 to 14 illustrate another embodiment of the present invention. In FIG. 8, a photo movie creating apparatus 30 is installed at DPE shops which offer a photo printing service, and it is operated by a customer. The photo movie creating apparatus 30 includes a memory 31, a CPU 32, a monitor display 33, an input operation section 34, a communication section 35, a media reader 37, and a media recorder 39. The memory 31, such as a hard disk type magnetic storage device, stores still image data for a photo movie and intermediate data produced in the arithmetic processing of the CPU 32. The CPU 32 runs each program stored in the memory 31. The monitor display 33 displays an edit menu as well as the created photo movies. The input operation section 34 will be, for example, a touch panel that constitutes a screen of the monitor display 33. By touching keys on the screen, parameters for photo movie creation are entered. The communication section 35 sends and receives image data to an external device such as the digital camera 36. The media reader 37 reads out the image data from the memory card 38 brought into by a customer. The media recorder 39 records the created photo movies to an optical disc 40 such as CD and DVD.

By executing the photo movie creating program stored in the memory 31, the CPU 32 will function as two different sections: a control section 45 that controls each part of the apparatus in response to the operations on the input operation section 34 and a photo movie creating section 46. The photo movie creating section 46 is made up of a cropping frame setup section 50 that produces a cropping frame for cutting off a part of a still image, a playback time setup section 51 that determines the playback time of each scene in a photo movie, and a photo movie output section 52 that outputs the moving image data of the photo movie.

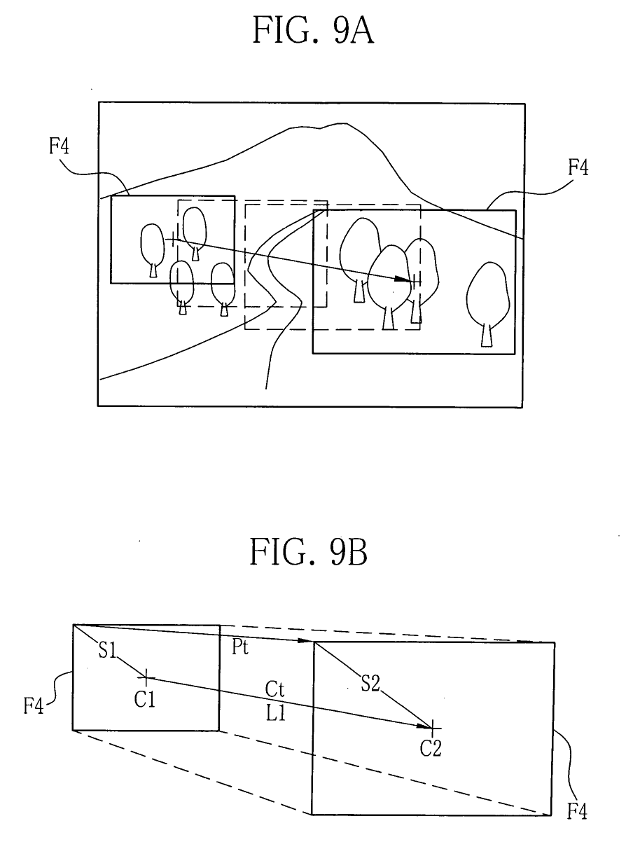

The cropping frame setup section 50 is composed of a moving path calculating section 55, a moving speed calculating section 56, a frame size adjustment section 57, and a moving distance adjustment section 58 as shown in FIGS. 9A and 9B. The moving path calculating section 55 calculates a moving path of a cropping frame F4, which moves within a still image to follow at least two points, such as a start point C1 and an end point C2, specified as the center coordinates of the cropping frame F4 by a user. As well as the start point C1 and the end point C2, the size of the cropping frame F4 at these two points should be specified as frame sizes S1 and S2. Since the cropping frame F4 is configured to preserve the same aspect ratio as a general home television screen, its vertical and lateral lengths will be instantly fixed only by deciding its diagonal length. In the drawings, the frame sizes S1 and S2 indicate the half diagonal length of the cropping frame F4.

The moving path of the cropping frame F4 is derived from three variables of the cropping frame F4 at each point in the playback time of a photo movie: the center coordinate Ct, the frame size St, and the coordinate Pt of a vertex. That is, if the frame size S1 at a start point C1 and the frame size S2 at an end point C2 are set to the different values, the frame size of the cropping frame F4 will change with time.

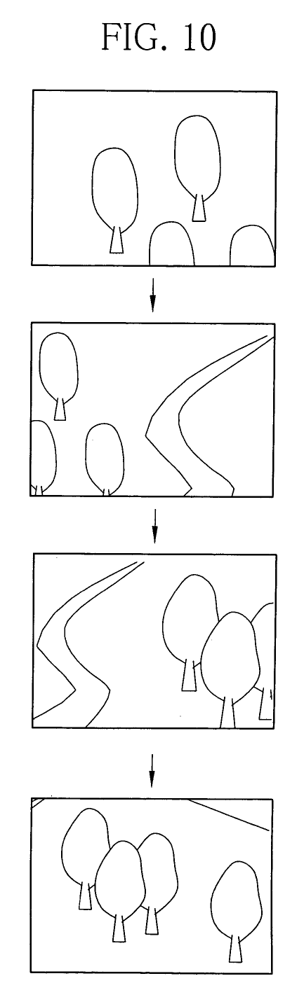

FIG. 10 shows one scene of the photo movie which is created by cutting off several portions of a still image at certain intervals with the cropping frame F4 that moves at a predetermined speed. The term none scene means a constitutional unit of a photo movie and is made up of plural images cut off from a single still image. These plural scenes are combined together to create a photo movie.

If the start point C1 and the end point C2 are set to the same position (or value) while the frame sizes S1 and S2 are set to different positions, a zooming effect will be produced. If different values are given to the start point C1 and the end point C2 while a same value is given to the frame sizes S1 and S2, a panning effect will be produced. Further, if the frame sizes S1 and S2 are set different and so do the start and end points C1 and C2, a combination of the zooming and panning effects is produced.

The moving speed calculating section 56 calculates a moving speed of the cropping frame F4 based on a moving distance L1 and the playback time of a scene. The frame size adjustment section 57 judges if this calculated moving speed is within a predetermined allowable speed range. One example of the allowable speed range, which will vary according to the resolution of still image, for the still image with 1280×960 pixels is 150-250 pixels per second. For still images with lower resolution, the allowable speed range shifts downward, while it shifts upward for still images with higher resolution. Note that the moving distance L1 of the cropping frame F4 is a distance for the center coordinates of the cropping frame F4 to move and, that is, a distance between the start point C1 and the end point C2 in FIG. 9B.

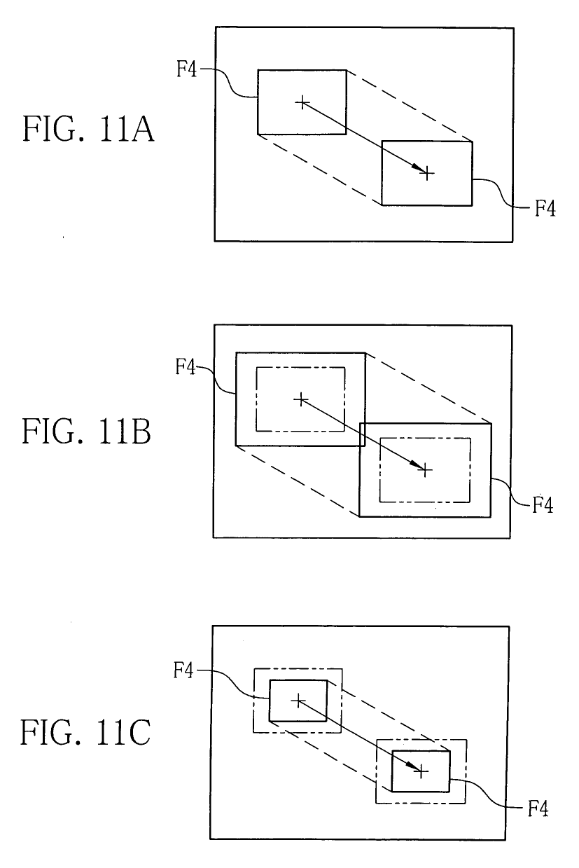

If the moving speed of the cropping frame F4 is out of the allowable speed range in FIG. 11A, the frame size adjustment section 57 adjusts the frame sizes S1 and S2 at the start point S1 and the end point S2. For example, if the moving speed goes over the allowable speed range, the frame sizes S1 and S2 are enlarged as shown in FIG. 11B. In the drawing, a chain double dashed line shows the initial frame size of the cropping frame, and a solid line shows the frame size after the adjustment. Each pixel is thereby displayed for a long time on the screen, and the harried scrolling of the scenes is prevented. If the moving speed goes below the allowable speed range, in contrast, the frame sizes S1 and S2 are reduced, as shown in FIG. 11C, so that each pixel is displayed for a short time on the screen. The size of the cropping frame F4 is determined by, for example, how far the moving speed is out of the allowable speed range. However, at the same time, the adjusted frame size must be within an allowable size range, which is determined according to the resolution of still image. The frame size adjustment section 57 judges if the adjusted frame size is within the allowable size range and, when the frame size goes out of the range, readjusts the cropping frame F4 to an allowable size.

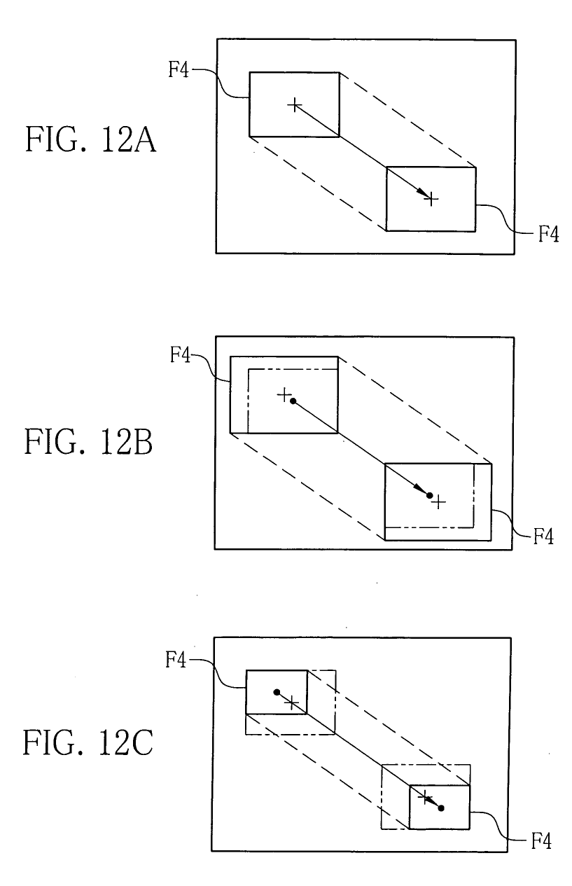

The cropping frame F4 readjusted in this way may sometime become unsuitable for the calculated moving speed. In this case, the moving distance adjustment section 58 changes the positions of the start point C1 and end point C2, i.e. the moving distance of the cropping frame. If, for example, the readjusted cropping frame is not large enough with respect to the calculated moving speed, the C1 and C2 are relocated, as shown in FIG. 12B, from the positions marked with crosses to the positions marked with dots so that the moving distance will be decreased. Thereby, the image becomes to scroll slowly on the screen. Alternatively, the readjusted cropping frame is not small enough, the C1 and C2 are relocated, as shown in FIG. 12C, from the positions marked with crosses to the positions marked with dots so that the moving distance will be increased.

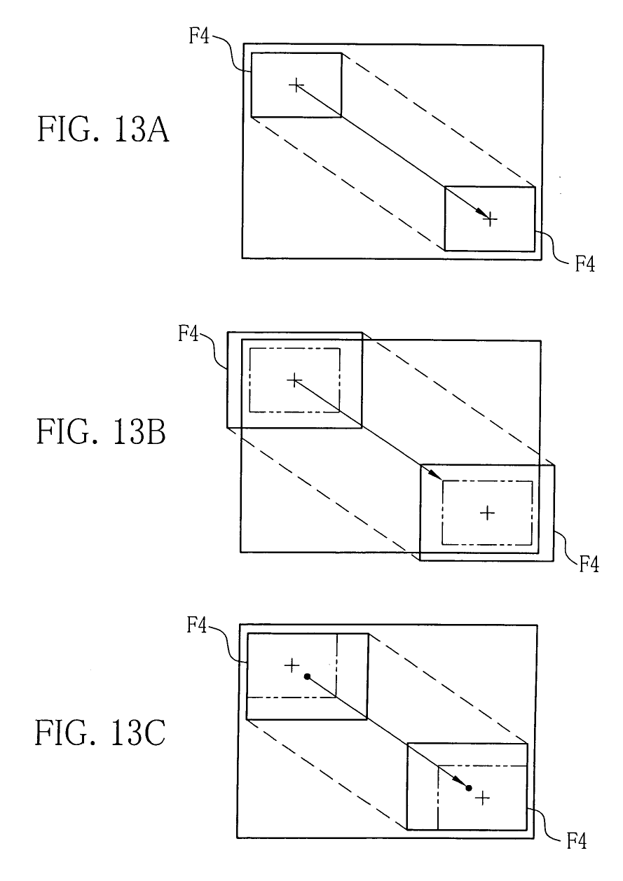

The moving distance adjustment section 58 also changes the start point C1 and end point C2 of the cropping frame F4 when a part of the cropping frame goes out of the still image. In FIG. 13A, both the start point C1 and end point C2 are placed near the edge of the still image. If the frame size adjustment section 57 enlarges the frame sizes Si and S2 at these points, the cropping frame F4 will partially go out of the still image, as shown in FIG. 13B. Therefore, in this case, the moving distance of the cropping frame is decreased by the moving distance adjustment section 58, as shown in FIG. 13C, so that the cropping frame F4 falls within the still image.

The moving distance adjustment section 58 adjusts the moving distance as little as possible to minimize the change in position of the start point C1 and end point C2. For example, the adjusted start point C1 and end point C2 are placed somewhere within the cropping frame F4 before adjustment in the still image. The change of the scrolling speed is kept to minimum before and after the moving distance adjustment.

The playback time setup section 51 determines the playback time for each scene. Although the playback time is initially set at a predetermined shortest playback time, such as 5 seconds, this default playback time can be changed later, where needed, on scene by scene basis. The playback time setup section 51 also calculates the total playback time of the photo movie after the setup of the cropping frame F4. Further, it adjusts the playback time of each scene When the user specified an intended total playback time.

The photo movie output section 52 sequentially transforms the cut off still images into the moving image frames for the photo movie, and generates moving image data at the rate of 30 frames per second. Also, the photo movie output section 52 transforms the generated moving image data into the data of, for example, MPEG2-DVD-Video format, and stores it in the memory 31. The moving image data in the memory 31 is then recorded to the optical disc 40 by the media recorder 39.

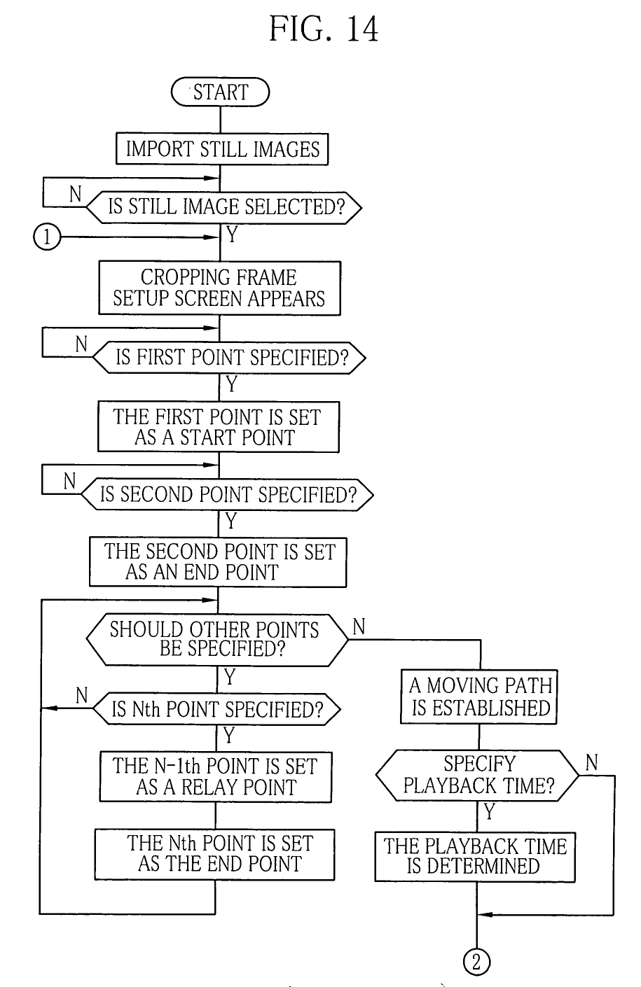

Next, the operation of the above embodiment is now explained. In FIG. 14, a user brings the digital camera 36 or the memory card 38, which stores the data of still images. The digital camera 36 is connected to the communication section 35, while the memory card 38 is set in the media reader 37. The control section 45 reads out the image data from the digital camera 36 or the memory card 38 and stores it in the memory 31.

The read still images are listed as thumbnail images on the monitor display 33. Selecting one of the still images for use in a scene of the photo movie will cause the monitor display 33 to display a cropping frame setup screen for setting up the cropping frame F4. At first, the selected still image is displayed on the cropping frame setup screen. By touching the surface of the display monitor 33, the user specifies any one point on the displayed image. The cropping frame setup section 50 reacts to put a mark on the specified point, as a first point, and produces the cropping frame F4. The cropping frame can be relocated by, for instance, dragging the mark to any place on the still image. Also, dragging one vertex of the cropping frame F4 will change the frame size S1 of the cropping frame F4. Once the position and size of the cropping frame F4 are determined, the cropping frame setup section 50 recognizes the first point as a start point C1.

Similarly, the user specifies a second point, and determines the position and the frame size S2 of the cropping frame F4. The cropping frame setup section 50 recognizes the second point as an end point C2. After the specification of the second point, the display monitor 33 shows a message of whether to specify intermediate points. To specify an intermediate point, the user should specify a third point and determine the position and size of the cropping frame F4. The third point is now recognized as a new end point C2, and the previous end point, i.e. the second point, becomes an intermediate point. A fourth point and fifth point may be specified in this manner.

After the specification of all points, the moving path of the cropping frame F4 is defined from the positions of the start, end, and intermediate points. In case that the frame sizes are different at the start point C1 and end point C2, the frame size is defined along time line. The display monitor 33 shows a message of whether to specify the playback time of each scene. In response to the specification of the playback time, the playback time setup section 51 changes the playback time of the scenes, or sets the playback time to the initial value, such as 5 seconds, if the playback time is not specified.

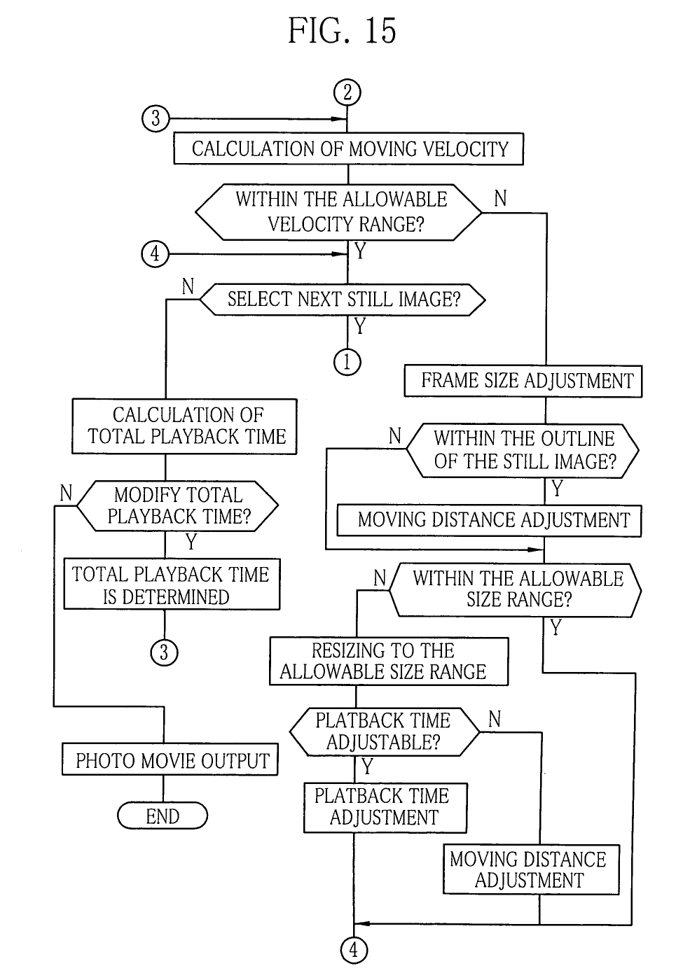

As shown in FIG. 15, the moving speed calculating section 56 calculates the moving speed of the cropping frame F4 based on the moving path and the playback time set as above. The frame size adjustment section 57 establishes an allowable speed range based on the resolution of the still image, and judges if the moving speed falls within the allowable speed range. If the moving speed proves within the allowable speed range, the setup of the cropping frame F4 is completed. The operation proceeds to either one of the succeeding steps of selecting a next still image or outputting the photo movie.

If the calculated moving speed proves outside the allowable speed range, on the other hand, the frame size adjustment section 57 changes the frame size of the cropping frame F4. Especially, the frame size is enlarged when the moving speed is over the range, while it is reduced when the moving speed is below the range. In addition, the frame size adjustment section 57 will check if the enlarged cropping frame F4 stays inside the still image. If not so, the moving distance adjustment section 58 changes the center position of the cropping frame F4 so that the enlarged cropping frame F4 can stay inside the still image.

The frame size adjustment section 57 establishes an allowable size range based on the resolution of the still image, and judges if the adjusted frame size falls within the allowable size range. If the frame size proves outside the range, the frame size adjustment section 57 will readjusts it forcibly to an allowable size. In case that the frame size is readjusted to a smaller size, the moving distance adjustment section 58 changes the start and end points so as to decrease the moving distance of the cropping frame F4. Contrary, in case that the frame size is readjusted to a larger size, the moving distance of the cropping frame F4 is increased. Then the moving distance adjustment section 58 calculates play back time after the change of the moving path, and sends the calculated playback time to the playback time setup section 51.

The playback time setup section 51 changes the current playback time of the scene into the calculated playback time, however, if the calculated playback time is less than the default value, i.e. 5 seconds, the current playback time is maintained. In this case, the moving distance is decreased by the moving distance adjustment section 58, and the setup of the cropping frame F4 is completed.

The same process is repeated to all the other selected still images. When the setup of the cropping frame F4 is completed in all the still image to be used for the photo movie, the playback time adjusting section 51 calculates a total playback time, which is the sum of the playback times of all the scenes. The total playback time is displayed on the display monitor 33, and if it is not desirable, the user may enter an intended playback time.

The total playback time setup section 51 detects the difference between the current total playback time and the intended total playback time. When extending the current total playback time, The total playback time setup section 51 extends the playback times of all the scenes evenly. When reducing the current total playback time, in contrast, the total playback time setup section 51 will only reduce the playback times of the scenes which are more than 5 seconds long. The scenes with extended or reduced playback time will go back to the moving speed calculation process, and their frame sizes and moving distances are adjusted.

After the adjustment of the total playback time, the photo movie output section 52 starts creating the photo movie. The photo movie output section 52 reads the information about each scene from both the cropping frame setup section 50 and the playback time setup section 51, and cuts off the portions of the still images based on the information about the cropping frame F4. The cut off images are transformed into moving picture frames, which are used to create the moving image data. The created moving image data is compressed under the MPEG compression method, and the compressed moving image data is transformed into the DVD-Video file format in the authoring process. The moving image data is stored in the memory 31 after the processes.

The moving image data of the photo movie in the memory 31 is then recorded by the media recorder 39 to the optical disc 40, which is delivered to the customer.

It is appreciated that the present invention is not limited to the above embodiment and several changes may be made thereto. Although the allowable speed range is defined with the upper and lower limits in the above embodiment, it may be defined with either one of the upper or lower limit.

In the above embodiment, the calculation of the moving speed and the adjustment of the frame size are performed to all the scenes in which the cropping frame is specified, it may however be possible to calculate an appropriate range of the playback time when the moving path and the frame size are specified and to perform the calculation of the moving speed and the adjustment of the frame size only when specified playback time is out of the calculated range.

The photo movie creating apparatus 30 described above is configured as the dedicated device which executes all the process from the reading of image data to the writing to optical discs. However, it may be composed of an order accepting device that executes from the reading of image data to the setup of special effects and a photo movie output device that receives the image data and setup information to create photo movies. In this case, the photo movie creating program of the present invention may be installed in a personal computer so that a customer is able to make an order from home via such a communication system as the internet.

The present invention can also be applied to digital still cameras. Additionally, the cropping frame is not limited to the rectangular shape but able to have a circular or rhombus shape. The special effects are not limited to the electronic zooming and panning effects, and a combination of the zooming, panning, and rotation effects can be used as long as the it involves the movement of the cropping frame.

As described so far, the present invention is not to be limited to the above embodiments, and all matter contained herein is illustrative and does not limit the scope of the present invention. Thus, obvious modifications may be made within the spirit and scope of the appended claims.

What is claimed is:

1. A photo movie creating apparatus for creating a photo movie by combining a plurality of scenes each of which is generated from at least one still image with special effects added thereto, comprising:
a memory for previously storing scene definition information, said scene definition information being given to each of said scenes and including at least one of parameters of a type of said special effects, the number of said still images to be used, and playback time of each of said scenes;
a total playback time calculator for calculating total playback time of said photo movie based on scene configuration information composed of a plurality of said scene definition information; and
a total playback time adjuster for changing said scene definition information without changing a total number of said still images to be used in said photo movie when an intended total playback time is provided by a user as a condition for creating said photo movie, so that said total playback time corresponds with said intended total playback time.

2. A photo movie creating apparatus as claimed in claim 1, wherein said total playback time adjuster changes said playback time parameter of each scene.

3. A photo movie creating apparatus as claimed in claim 2, wherein if said special effects include a frame move effect which changes a display size of said still image smaller than a display screen and moves said still image on said display screens said total playback time adjuster changes said display size of said still image in response to said change of playback time parameter so as to change a moving distance of said still image on said display screen.

4. A photo movie creating apparatus as claimed in claim 3, wherein said total playback time adjuster enlarges said display size of said still image so as to decrease said moving distance when reducing said playback time of scene.

5. A photo movie creating apparatus as claimed in claim 2, wherein if said special effects include an electronic panning effect for partially scrolling said still image by enlarging a cut off portion of said still image on a display screen while moving a position of said cut off portion in said still image, said total playback time adjuster changes a size of said cut off portion in response to said change of playback time parameter so as to change an amount of said scrolling.

6. A photo movie creating apparatus as claimed in claim 5, wherein said total playback time adjuster enlarges said size of said cut off portion so as to decrease said amount of said scrolling when reducing said playback time of scene.

7. A photo movie creating apparatus as claimed in claim 2, wherein if said special effects include an electronic zooming effect that apparently zooming in or out to said still image, said total playback time adjuster changes an amount of said zooming in response to said change of playback time parameter.

8. A photo movie creating apparatus as claimed in claim 7, wherein said total playback time adjuster decreases said amount of said zooming when reducing said playback time of scene.

9. A photo movie creating apparatus as claimed in claim 1, wherein said total playback time adjuster changes other parameters than said type of special effects.

10. A photo movie creating apparatus as claimed in claim 1, wherein said total playback time adjuster changes total number of said scene definition information included in said scene configuration information by changing a type of said scene definition information to change the number of still images to be used in one scene.

11. A photo movie creating apparatus as claimed in claim 1, wherein said total playback time adjuster changes said total playback time when audio data is provided for said photo movie, so that said total playback time corresponds with the playback time of said audio data.

12. A photo movie creating apparatus as claimed in claim 1, further comprising:
a scene configuration information creator for creating said scene configuration information according to either one of a first step enabling a user to select a template of said scene definition information for each scene or a second step enabling said user to select a template of said scene configuration information.

13. A photo movie creating program for operating a computer to execute a process of creating a photo movie by combining a plurality of scenes each of which is generated from at least one still image with special effects added thereto, the process comprising the steps of:
calculating total playback time of said photo movie based on scene configuration information composed of a plurality of said scene definition information which includes at least one of parameters of a type of said special effects, the number of said still images to be used, and playback time of each of said scenes; and
changing said scene definition information without changing a total number of still images to be used in said photo movie when an intended total playback time is provided by a user, so that said total playback time corresponds with said intended total playback time.

14. A photo movie creating apparatus for creating a photo movie from a plurality of images each of which is cut off from a still image with a cropping frame for cutting off a portion of said still image, said cropping frame cutting off said plurality of images while moving on a moving path which connects at least two points on said still image, said photo movie creating apparatus comprising:
a moving speed calculator for calculating a moving speed of said cropping frame based on a size of said cropping frame and playback time of said photo movie; and
a frame size adjuster for comparing said moving speed with a predetermined allowable speed range and for changing said size of said cropping frame when said moving speed is out of said allowable speed range.

15. A photo movie creating apparatus as claimed in claim 14, wherein said frame size adjuster enlarges said size of said cropping frame when said moving speed is beyond said allowable speed range and reduces said size of said cropping frame when said moving speed is below said allowable speed range.

16. A photo movie creating apparatus as claimed in claim 14, further comprising:
a moving distance adjuster for changing a length of said moving path while maintaining the connection of said points when said moving speed is out of said allowable speed range.

17. A photo movie creating apparatus as claimed in claim 16, wherein said moving distance adjuster decreases said length of said moving path when said moving speed is beyond said allowable speed range and increases said length of said moving path when said moving speed is below said allowable speed range.

18. A photo movie creating apparatus as claimed in claim 17, wherein said moving distance adjuster decrease said length of said moving path when at least a portion of said cropping frame is out of said still image so that said cropping frame falls within said still image.

19. A photo movie creating program for operating a computer to execute a process of creating a photo movie from a plurality of images each of which is cut off from a still image with a cropping frame for cutting off a portion of said still image, said cropping frame cutting off said plurality of images while moving along a moving path formed to connect at least two points on said still image, said process comprising the steps of:
calculating a moving speed of said cropping frame based on a size of said cropping frame and playback time of said photo movie; and
comparing said moving speed with a predetermined allowable speed range and changing said size of said cropping frame when said moving speed is out of said allowable speed range.
